(19) United States
(12) Patent Application Publication
(10) Pub. No.: US 2015/0208370 A1
(43) Pub. Date: Jul. 23, 2015

(54) METHOD AND APPARATUS FOR TIME SYNCHRONIZATION IN WIRELESS NETWORK

(71) Applicant: Electronics & Telecommunications Research Institute, Daejeon (KR)

(72) Inventors: Ji Hung KIM, Daejeon (KR); Jun Hwan LEE, Seoul (KR)

(21) Appl. No.: 14/600,377

(22) Filed: Jan. 20, 2015

(30) Foreign Application Priority Data
Jan. 20, 2014 (KR) 10-2014-0006423

(51) Int. Cl. H04W 56/00

(52) U.S. Cl. CPC H04W 56/001

(57) ABSTRACT

Disclosed are a time synchronization method and apparatus in a wireless network. The time synchronization method includes estimating a round trip delay (RTD) time among the plurality of small base stations, generating time information for time synchronization among the plurality of small base stations based on the RTD time, and transmitting the time information to the plurality of small base stations. Therefore, it is possible to synchronizing a time between the base stations.

### CLAIM FOR PRIORITY

This application claims priority to Korean Patent Application No. 2014-0006423 filed on Jan. 20, 2014 in the Korean Intellectual Property Office (KIPO), the entire contents of which are hereby incorporated by reference.

### BACKGROUND

1. Technical Field

Example embodiments of the present invention relate in general to time synchronization technology and more specifically to a method and apparatus for time synchronization among base stations in a wireless network.

2. Related Art

In a cellular communication system based on orthogonal frequency division multiple access (OFDMA), a terminal may set time synchronization with a base station by receiving a timing advance value through a ranging process with the base station. For this, the terminal transmits a ranging preamble (or physical random access channel (PRACH)) to the base station. The base station may measure a round trip delay (RTD) time by receiving the ranging preamble (or PRACH) from the terminal, and transmit the timing advance value for compensating for RTD/2 to the terminal based on the measured value. Here, the terminal may refer to a small (or individual) base station.

The small (or individual) base station may set time synchronization with a macro base station in the same manner as that of the terminal. The small base station may perform a time synchronization process in order to receive a timing advance value for compensating for RTD/2 with the macro base station even when autonomously sets time synchronization using a global positioning system (GPS).

Meanwhile, even when time synchronization between the small base station and the macro base station is set, time synchronization for communication between the small base stations is required to be set. In addition, even when the macro base station sets a long cyclic prefix (CP) in consideration of a cell radius covered by the macro base station itself, a time synchronization process between the small base stations is necessary. That is, when performing communication with other small base stations by applying the timing advance value received in the time synchronization process with the macro base station, an arbitrary small base station may not receive an OFDM symbol within the CP.

Another problem is associated with channel estimation. That is, the base station uses an interpolation method when estimating a channel through a pilot subcarrier, but when applying the interpolation method on a frequency axis, the base station needs to know a difference between a reception time of a symbol and a starting point of fast fourier transform (FFT) in order to improve accuracy of channel estimation even though the symbol is received within the CP. In addition, the base station needs to know a difference between a previously acquired channel correlation value and a current channel correlation value even when applying a minimum mean squared error (MMSE) channel estimation method, and therefore the base station needs to know the difference between the reception time of the symbol and the starting point of FFT.

### SUMMARY

Accordingly, example embodiments of the present invention are provided to substantially obviate one or more problems due to limitations and disadvantages of the related art.

Example embodiments of the present invention provide a time synchronization method for setting time synchronization among base stations.

Example embodiments of the present invention also provide a time synchronization apparatus for setting time synchronization among base stations.

In some example embodiments, a time synchronization method performed in a central base station for controlling a plurality of small base stations includes: estimating a round trip delay (RTD) time among the plurality of small base stations; generating time information for time synchronization among the plurality of small base stations based on the RTD time; and transmitting the time information to the plurality of small base stations.

Here, the estimating of the RTD time may include receiving position information from each of the small base stations, calculating distance information among the plurality of small base stations based on the position information, and estimating the RTD time among the plurality of small base stations based on the distance information.

Also, when the position information is received, a ranging message including the position information may be received.

Also, the estimating of the RTD time may include transmitting a sector beam to each sector within a cell, receiving beam index information determined based on a reception state of the sector beam from the plurality of small base stations, and estimating the RTD time among the plurality of small base stations based on the beam index information.

Also, the beam index information may be index information about a sector beam that satisfies a signal to noise ratio (SNR) set in advance.

Also, the time information may include a timing advance value for time synchronization among the plurality of small base stations.

Also, the central base station may have a cell radius larger than that of the small base station.

In other example embodiments, a central base station for controlling a plurality of small base stations includes: a processing unit that estimates a RTD time among the plurality of small base stations, generates time information for time synchronization among the plurality of small base stations based on the RTD time, and transmits the time information to the plurality of small base station; and a storage unit that stores information to be processed in the processing unit and information having been processed in the processing unit.

Here, when estimating the RTD time, the processing unit may receive position information from each of the small base stations, calculate distance information among the plurality of small base stations based on the position information, and estimate the RTD time among the plurality of small base stations based on the distance information.

Also, when receiving the position information, the processing unit may receive a ranging message including the position information.

Also, when estimating the RTD time, the processing unit may transmit a sector beam to each sector within a cell, receive beam index information determined based on a reception state of the sector beam from the plurality of small base station, and estimate the RTD time among the plurality of small base stations based on the beam index information.

Also, the beam index information may be index information about a sector beam that satisfies an SNR set in advance.

Also, the time information may include a timing advance value for time synchronization among the plurality of small base stations.

Also, the central base station may have a cell radius larger than that of the small base station.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a configuration of a cell in which a plurality of base stations are present;

FIG. 2 is a conceptual diagram illustrating a symbol transmission/reception timing among small base stations;

FIG. 3 is a flowchart illustrating a time synchronization method among base stations according to an embodiment of the present invention;

FIG. 4 is a flowchart illustrating a time synchronization method among base stations according to another embodiment of the present invention;

FIG. 5 is a conceptual diagram illustrating a process of estimating a round trip delay (RTD) time using a sector beam; and

FIG. 6 is a block diagram illustrating a configuration of a central base station according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

In the entire specification, a network may include a wireless Internet such as wireless fidelity (WiFi), a portable Internet such as a wireless broadband internet (WiBro), or a world interoperability for microwave access (WiMax), a 2G mobile communication network such as a global system for mobile communication (GSM) or a code division multiple access (CDMA), a 3G mobile communication network such as a wideband code division multiple access (WCDMA) or a CDMA2000, a 3.5G mobile communication network such as a high speed downlink packet access (HSDPA) or a high speed uplink packet access (HSUPA), a 4G mobile communication network such as a long term evolution (LTE) network or an LTE-Advanced network, a 5G mobile communication network, and the like.

In the entire specification, a terminal may refer to a mobile station, a mobile terminal, a subscriber station, a portable subscriber station, user equipment, an access terminal, or the like, and include some or all functions thereof.

Here, as the terminal, a desktop computer capable of communication, a laptop computer, a tablet PC, a wireless phone, a mobile phone, a smart phone, an e-book reader, a portable multimedia player (PMP), a portable game machine, a navigation device, a digital camera, a digital multimedia broadcasting (DMB) player, a digital audio recorder, a digital audio player, a digital picture recorder, a digital picture player, a digital video recorder, a digital video player, or the like may be used.

In the entire specification, a base station may refer to an access point, a radio access station, a node B, an evolved node B, a base transceiver station, a mobile multihop relay (MMR)-BS, or the like, and include some or all functions thereof.

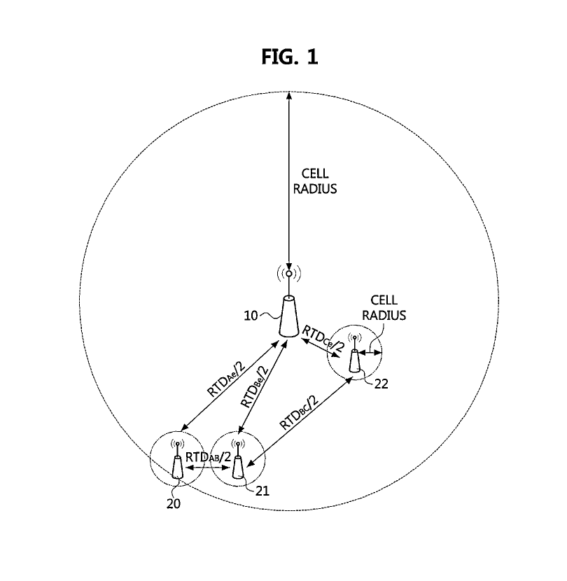

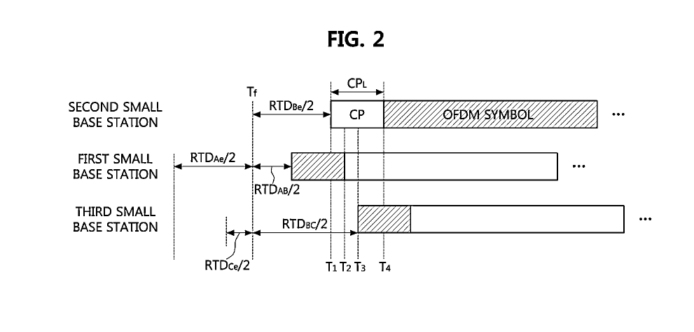

FIG. 1 is a conceptual diagram illustrating a configuration of a cell in which a plurality of base stations are present, and FIG. 2 is a conceptual diagram illustrating a symbol transmission/reception timing among small base stations.

Referring to FIGS. 1 and 2, a plurality of small (or individual) base stations 20, 21, and 22 may be present within a cell range of a central base station 10. The central base station 10 may refer to a macro base station, and the cell range of the central base station 10 is larger than a cell range of each of the small base stations 20, 21, and 22.

Each of the small base stations 20, 21, and 22 may refer to a femto base station, a pico base station, or the like. That is, each of the small base stations 20, 21, and 22 may refer to a base station having a smaller cell radius than that of the central base station 10.

Here, RTD_{Ae} denotes a round trip delay (RTD) time between the central base station 10 and the first small base station 20, RTD_{Be} denotes an RTD time between the central base station 10 and the second small base station 21, and RTD_{Ce} denotes an RTD time between the central base station 10 and the third small base station 22. In addition, RTD_{AB} denotes an RTD time between the first small base station 20 and the second small base station 21, and RTD_{BC} denotes an RTD time between the second small base station 21 and the third small base station 22.

When it is assumed that a frame starting time is T_{f}, a timing advance value for synchronization setting between the central base station 10 and each of the small base stations 20, 21, and 22 will be set as follows.
First small base station 20: T_{f}−RTD_{Ae}/2
Second small base station 21: T_{f}−RTD_{Be}/2
Third small base station 22: T_{f}−RTD_{Ce}/2

Hereinafter, when the first small base station 20 and the third small base station 22 transmit a symbol at the set time, and the second small base station 21 receives the transmitted symbol, a symbol transmission/reception timing among the small base stations 20, 21, and 22 will be described.

The second small base station 21 may set T₄ as a starting point of fast fourier transform (FFT) by reception setting with the central base station 10. Based on this, each time T₁, T₂, T₃, and T₄ may be expressed as follows.

T₁=T_{f}+RTD_{Be}/2

T₂=T_{f}+(RTD_{AB}/2−RTD_{Ae}/2)+CP_{L}

T₃=T_{f}+(RTD_{BC}/2−RTD_{Ce}/2)

T₄=T1+CP_{L}

When receiving signals transmitted from the first small base station 20, the second small base station 21 needs to change the starting point of FFT into an arbitrary time between T₁ and T₂ in order to restore the signals without inter symbol interference (ISI) and inter carrier interference (ICI).

In addition, when receiving signals transmitted from the third small base station 22, the second small base station 21 needs to change the starting point of FFT into an arbitrary time between T₃ and T₄ in order to restore the signals without ISI and ICI. In this case, the starting point of FFT of the second small base station 21 is T₄, and therefore there is no need to change the starting point of FFT. However, in order to increase accuracy of channel estimation, it is necessary to know a time difference between T₃ and T₄.

Consequently, in order to improve detection accuracy of received signals in the second small base station 21, the following two methods may be applied.

First method: method in which the first small base station 20 and the third small base station 22 apply a new timing advance value so that signals transmitted from the first small base station 20 and the third small base station 22 reach T₁ of the second small base station 21

Second method: method in which signals are received at an accurate timing in such a manner that the first small base station 20 and the third small base station 22 use an existing timing advance value (that is, a timing advance value between the central base stations 10) and the second small base station 21 knows a reception time of the signals transmitted from each of the small base stations 20 and 22.

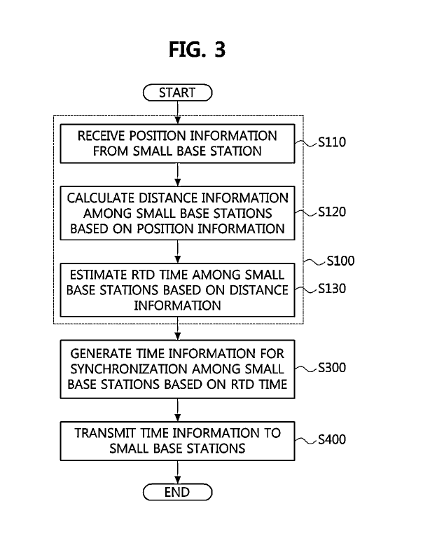

FIG. 3 is a flowchart illustrating a time synchronization method among base stations according to an embodiment of the present invention. Hereinafter, a time synchronization method is assumed to be performed by the central base station 10 and the plurality of small base stations 20, 21, and 22 which are shown in FIGS. 1 and 2, and will be described.

Referring to FIG. 3, in operation S100, the central base station 10 may estimate a round trip delay (RTD) time among a plurality of small (or individual) base stations 20, 21, and 22. The central base station 10 may refer to a macro base station, and have a larger cell range than that of each of the small base stations 20, 21, and 22. Each of the small base stations 20, 21, and 22 may refer to a femto base station, a pico base station, or the like, and may be present within a cell range of the central base station 10. That is, the central base station 10 may exchange signals with the plurality of small base stations 20, 21, and 22.

In operation S110, the central base station 10 may receive position information from each of the small base stations 20, 21, and 22. The position information may refer to a coordinate value acquired from a global positioning system (GPS) positioned in each of the small base stations 20, 21, and 22. That is, each of the small base stations 20, 21, and 22 may acquire its own coordinate value using the GPS device, and transmit the acquired coordinate value to the central base station 10. In this instance, each of the small base stations 20, 21, and 22 may generate a ranging message including the position information (that is, coordinate value), and transmit the generated ranging message to the central base station 10.

The central base station 10 may calculate distance information among the plurality of small base stations 20, 21, and 22 based on the position information in operation S120, and estimate an RTD time among the plurality of small base stations 20, 21, and 22 based on the calculated distance information in operation S130.

The central base station 10 may generate time information for time synchronization among the plurality of small base stations 20, 21, and 22 based on the estimated RTD time in operation S300, and transmit the generated time information to the plurality of small base stations 20, 21, and 22 in operation S400.

As an example, when an arbitrary N-th small base station transmits a frame to the second small base station 21, the central base station 10 may generate time information including ‘RTD_{Ne}/2 (RTD time/2 between the N-th small base station and the central base station 10)−RTD_{NB}/2 (RTD time/2 between the N small base station and the second small base station 21)’, that is, a new timing advance value, and transmit the generated time information to the N-th small base station. The N-th small base station that has received the time information may transmit a frame to the second small base station 21 at ‘T_{f} (frame starting time)+(RTD_{Ne}/2−RTD_{NB}/2)’.

As another example, when an arbitrary N-th small base station transmits a frame to the second small base station 21, the central base station 10 may transmit ‘RTD_{Ne}/2−RTD_{NB}/2’, that is, a difference in reception times to the second small base station 21. The second small base station 21 that has received the time information may determine a starting time of FFT and a value (CH_{B}) to be reflected to channel estimation as in the following Equation 1.

$$FFT \text{:} T 4 - ( \frac{{RTD}_{Ne}}{2} - \frac{{RTD}_{NB}}{2} ) , \\ {CH}_{S} \text{:} 0 if \frac{{RTD}_{Ne}}{2} - \frac{{RTD}_{NB}}{2} > 0 \\ FFT \text{:} T 4 , {CH}_{S} \text{:} ( \frac{{RTD}_{Ne}}{2} - \frac{{RTD}_{NB}}{2} ) if \\ \frac{{RTD}_{Ne}}{2} - \frac{{RTD}_{NB}}{2} \leq 0 \qquad [ Equation 1 ]$$

Here, T4 denotes T₄ shown in FIG. 2, RTD_{Ne} denotes an RTD time between an N-th small base station and the central base station 10, and RTD_{NB} denotes an RTD time between the N-th small base station and the second small base station 21.

The second small base station 21 may receive a frame transmitted from an arbitrary N-th small base station based on a starting point of FFT calculated through Equation 1 and a value to be reflected to channel estimation.

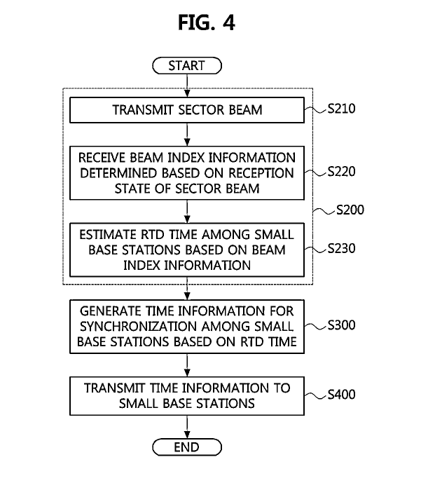

FIG. 4 is a flowchart illustrating a time synchronization method among base stations according to another embodiment of the present invention. Hereinafter, a time synchronization method is assumed to be performed by the central base station 10 and the plurality of small base stations 20, 21, and 22 which are shown in FIGS. 1 and 2, and will be described.

Referring to FIG. 4, in operation S200, the central base station 10 may estimate an RTD time among the plurality of small (or individual) base stations 20, 21, and 22. The central base station 10 has a larger cell range than that of each of the plurality of small base stations 20, 21, and 22. Each of the small base stations 20, 21, and 22 may refer to a femto base station, a pico base station, or the like, and may be present within a cell range of the central base station 10. That is, the central base station 10 may exchange signals with the plurality of small base stations 20, 21, and 22.

When estimating the RTD time, the central base station 10 may transmit a sector beam to each sector within the cell in operation S210, receive beam index information determined based on a reception state of the sector beam from the plurality of small base stations 20, 21, and 22, and estimate the RTD time among the plurality of small base stations 20, 21, and 22 based on the beam index information.

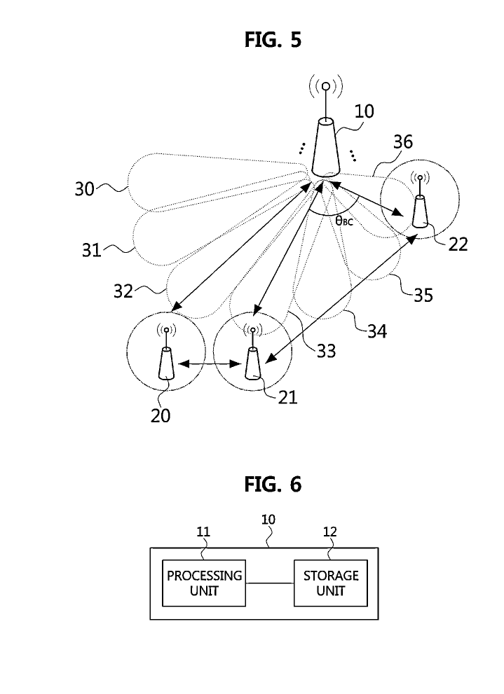

Hereinafter, a method in which the central base station 10 estimates the RTD time will be described below in detail with reference to FIG. 5.

FIG. 5 is a conceptual diagram illustrating a process of estimating an RTD time using a sector beam. Here, arrangement among the base stations shown in FIG. 5 is the same as arrangement among the base stations shown in FIG. 1.

Referring to FIG. 5, the central base station 10 may transmit sector beams 30, 31, 32, 33, 34, 35, and 36 by applying a beamforming method to preamble signals. Each of the sector beams 30, 31, 32, 33, 34, 35, and 36 may include its own beam index information. Each of the small base stations 20, 21, and 22 may receive the plurality of sector beams 30, 31, 32, 33, 34, 35, and 36, determine a single sector beam (for example, a sector beam having the largest signal to noise ratio (SNR)) larger than an SNR set in advance among the received sector beams 30, 31, 32, 33, 34, 35, and 36, and transmit index information about the determined sector beam to the central base station 10.

For example, the first small base station 20 may determine the third sector beam 32 among the received sector beams as the sector beam satisfying the SNR set in advance, and transmit beam index information about the third sector beam 32 to the central base station 10. The second small base station 21 may determined the fourth sector beam 33 among the received sector beams as the sector beam satisfying the SNR set in advance, and transmit beam index information about the fourth sector beam 33 to the central base station 10. The third small base station 22 may determine the seventh sector beam 36 among the received sector beams as the sector beam satisfying the SNR set in advance, and transmit beam index information about the seventh sector beam 36 to the central base station 10.

The central base station 10 may estimate the RTD time among the plurality of small base stations 20, 21, and 22 based on the beam index information received from the plurality of small base stations 20, 21, and 22.

For example, when estimating an RTD time RTD_{BC} between the second small base station 21 and the third small base station 22, the central base station 10 may estimate an angle θ_{BC} between the fourth sector beam 33 and the seventh sector beam 36 based on the beam index information, and estimate RTD_{BC} through the following Equation 2 based on the estimated angle.

$$\sqrt{{( \frac{{RTD}_{Ce}}{2} sin {θ}_{BC} )}^{2} + {( \frac{{RTD}_{Se}}{2} - \frac{{RTD}_{Ce}}{2} cos {θ}_{BC} )}^{2}} \qquad [ Equation 2 ]$$

Here, RTD_{Ce} denotes an RTD time between the central base station 10 and the third small base station 22, and RTD_{Be} denotes an RTD time between the central base station 10 and the second small base station 21.

In the same manner, the central base station 10 may estimate an RTD time RTD_{AB} between the first small base station 20 and the second small base station 21 and an RTD time RTD_{CA} between the first small base station 20 and the third small base station 22.

Referring again to FIG. 4, the central base station 10 may generate time information for time synchronization among the plurality of small base stations 20, 21, and 22 based on the estimated RTD time in operation S300, and transmit the generated time information to the plurality of small base stations 20, 21, and 22 in operation S400.

As an example, when an arbitrary N-th small base station transmits a frame to the second small base station 21, the central base station 10 may generate time information including ‘RTD_{Ne}/2 (RTD time/2 between the N-th small base station and the central base station 10)−RTD_{NB}/2 (RTD time/2 between the N-th small base station and the second small base station 21)’, that is, a new timing advance value, and transmit the generated time information to the N-th small base station. The N-th small base station that has received the time information may transmit a frame to the second small base station 21 at ‘T_{f} (frame starting time)+(RTD_{Ne}/2−RTD_{NB}/2)’.

As another example, when the arbitrary N-th small base station transmits the frame to the second small base station 21, the central base station 10 may transmit ‘RTD_{Ne}/2−RTD_{NB}/2’, that is, a difference in reception times to the second small base station 21. The second small base station 21 that has received the time information may determine the starting point of FFT and the value to be reflected to the channel estimation as in Equation 1.

The second small base station 21 may receive the frame transmitted from the arbitrary N-th small base station based on the starting point of FFT and the value to be reflected to the channel estimation calculated through Equation 1.

FIG. 6 is a block diagram illustrating a configuration of a central base station according to an embodiment of the present invention.

Referring to FIG. 6, the central base station 10 may include a processing unit 11 and a storage unit 12. The processing unit 11 may estimate an RTD time among a plurality of small (or individual) base stations, generate time information for time synchronization among the plurality of small base stations based on the RTD time, and transmit the generated time information to the plurality of small base stations.

Here, the central base station 10 may refer to a macro base station, and the small base station may be present within a cell range of the central base station 10. The small base station may refer to a femto base station, a pico base station, or the like. That is, the cell range of the central base station 10 may be larger than a cell range of the small base station.

The processing unit 11 may use two methods when estimating an RTD time among a plurality of small base stations. In a first method, as in operation S100 of FIG. 3, the processing unit 11 may receive position information (that is, ranging message including position information) from each of the small base stations, calculate distance information among the plurality of small base stations based on the position information, and estimate the RTD time among the plurality of small base station based on the calculated distance information. That is, a specific method of estimating the RTD time may be the same as operation S100 that has been described with reference to FIG. 3.

In a second method, as in operation S200 of FIG. 4, the processing unit 11 may transmit a sector beam to each sector within a cell, receive beam index information (that is, index information about a sector beam satisfying an SNR set in advance) determined based on a reception state of the sector beam from the plurality of small base stations, and estimate the RTD time among the plurality of small base stations based on the received beam index information. That is, a specific method of estimating the RTD time may be the same as operation S200 that has been described with reference to FIG. 4 and the process that has been described with reference to FIG. 5.

Meanwhile, the processing unit 11 may generate a time advance value for time synchronization among the plurality of small base stations based on the time information. The processing unit 11 may transmit the generated time information to a small base station to transmit the frame or a small base station to receive the frame. For example, when receiving the time information, the small base station to transmit the frame may transmit the frame at a transmission time set based on the time information. On the other hand, when receiving the time information, the small base station to receive the frame may receive the frame at a reception time set based on the time information.

Here, the processing unit 11 may include a processor and a memory. The processor may refer to a general purpose processor (for example, central processing unit (CPU) or the like) or a dedicated processor for performing the time synchronization method. In the memory, a program code for performing the time synchronization method may be stored. That is, the processor may read the program code stored in the memory, and perform each operation of the time synchronization method based on the read program code.

The storage unit 12 may store information to be processed in the processing unit 11 and information having been processed. For example, the storage unit 12 may store an RTD time, time information (that is, timing advance value), beam index information, and the like.

According to the embodiments of the present invention, it is possible to synchronize time among the base stations, thereby improving detection performance of received signals in communication among the base stations.

While the example embodiments of the present invention and their advantages have been described in detail, it should be understood that various changes, substitutions and alterations may be made herein without departing from the scope of the invention.

What is claimed is:

1. A time synchronization method performed in a central base station for controlling a plurality of small base stations, comprising:
estimating a round trip delay (RTD) time among the plurality of small base stations;
generating time information for time synchronization among the plurality of small base stations based on the RTD time; and
transmitting the time information to the plurality of small base stations.

2. The time synchronization method of claim 1, wherein the estimating of the RTD time includes receiving position information from each of the small base stations,
calculating distance information among the plurality of small base stations based on the position information, and
estimating the RTD time among the plurality of small base stations based on the distance information.

3. The time synchronization method of claim 2, wherein, when the position information is received, a ranging message including the position information is received.

4. The time synchronization method of claim 1, wherein the estimating of the RTD time includes
transmitting a sector beam to each sector within a cell,
receiving beam index information determined based on a reception state of the sector beam from the plurality of small base stations, and
estimating the RTD time among the plurality of small base stations based on the beam index information.

5. The time synchronization method of claim 4, wherein the beam index information is index information about a sector beam that satisfies a signal to noise ratio (SNR) set in advance.

6. The time synchronization method of claim 1, wherein the time information includes a timing advance value for time synchronization among the plurality of small base stations.

7. The time synchronization method of claim 1, wherein the central base station has a cell radius larger than that of the small base station.

8. A central base station for controlling a plurality of small base stations, comprising:
a processing unit that estimates a RTD time among the plurality of small base stations, generates time information for time synchronization among the plurality of small base stations based on the RTD time, and transmits the time information to the plurality of small base station; and
a storage unit that stores information to be processed in the processing unit and information having been processed in the processing unit.

9. The central base station of claim 8, wherein, when estimating the RTD time, the processing unit receives position information from each of the small base stations, calculates distance information among the plurality of small base stations based on the position information, and estimates the RTD time among the plurality of small base stations based on the distance information.

10. The central base station of claim 9, wherein, when receiving the position information, the processing unit receives a ranging message including the position information.

11. The central base station of claim 8, wherein, when estimating the RTD time, the processing unit transmits a sector beam to each sector within a cell, receives beam index information determined based on a reception state of the sector beam from the plurality of small base station, and estimates the RTD time among the plurality of small base stations based on the beam index information.

12. The central base station of claim 11, wherein the beam index information is index information about a sector beam that satisfies an SNR set in advance.

13. The central base station of claim 8, wherein the time information includes a timing advance value for time synchronization among the plurality of small base stations.

14. The central base station of claim 8, wherein the central base station has a cell radius larger than that of the small base station.
